(19) United States
(12) Patent Application Publication
(10) Pub. No.: US 2021/0170548 A1
(43) Pub. Date: Jun. 10, 2021

(54) KNIFE BLADE SHARPENING DEVICE AND METHOD

(71) Applicant: HENRY JOHNSON PTY LTD AS TRUSTEE FOR THE HENRY JOHNSON FAMILY TRUST, Kenmore Hills (AU)

(72) Inventor: MARK JAMES HENRY, Kenmore Hills (AU)

(21) Appl. No.: 17/106,387

(22) Filed: Nov. 30, 2020

Related U.S. Application Data
(60) Provisional application No. 62/943,332, filed on Dec. 4, 2019.

(51) Int. Cl. B24D 15/08; B24B 3/54

(52) U.S. Cl. CPC B24D 15/085; B24B 3/54

(57) ABSTRACT

The device includes a holder for retaining the knife blade in a fixed position with the cutting edge accessible from above. One end of a moveable abrasive part is situated above the cutting edge. The other end of the abrasive part is supported by a retaining member and sets the angle of the abrasive part relative to the knife blade when the abrasive surface contacts the cutting edge. The cutting edge is sharpened as the abrasive part in contact with the cutting edge is moved along the length of the knife blade. The abrasive part may be a stone or a rod with an abrasive surface. The retaining part may have a ring shape or take the form of a clamp which attaches to the stone in different positions.

### BACKGROUND OF THE INVENTION

### 1. Field of the Invention

The present invention relates to knives and more particularly, to a simplified and accurate method of sharpening a knife blade and a device for practicing the method.

### 2. Description of Prior Art Including Information Disclosed Under 37 CFR 1.97 and 1.98

Many gadgets to help speed and simplify the process of knife sharpening exist. Most involve a simple drag-through motion, using coarse cutting blades or electric powered abrasives, and are targeted at consumers, home cooks or sporting knife users. Those gadgets tend to produce blades with very coarse edges and remove more blade material than necessary. Serious knife users avoid them due to their unsatisfactory results for fine knife blades.

It is well known among expert knife/sword users that sharpening any type of blade with Japanese water stones can produce the finest results, though a high level of skill, and a lot of time is required. Time invested in years of practical experience, and sometimes hours invested in sharpening each blade.

Even for experienced knife sharpeners, the key difficulty with stones is maintaining an accurate angle between the moving blade held in the hand, and the fixed stone resting on the bench top. The compound curves of blades make the required 3D arc motion very complex and difficult for human operators. Very few Western knife users have mastered this difficult traditional stone sharpening skill. Even among those who have developed the competency, many often don't have time to use this time-consuming method.

In an effort to eliminate this inherent human error, many sharpening systems have been invented which mount a blade rigidly, then allow adjustment of the blade or the abrasive rod by various means. All the prior art in this field involves relatively complex jigs, fixtures, clamps, rod mounts, etc, and their complexity often requires as much time ins setup as that saved in sharpening. The perception is that they are generally too complex for the average home knife user, and they are therefore used by a small niche of enthusiasts.

### BRIEF SUMMARY OF THE INVENTION

The present invention eliminates human error from the sharpening process, while allowing for high quality traditional Japanese stones to be used, for finest results. In place of a traditional stone, any other suitable abrasive material can be used (such as diamond-coated metal rod, ceramic, composite resin abrasives, etc).

The process is ‘inverted’ from the traditional method, with the blade being held rigid on the bench, and the stone moved relative to the blade, sharpening from on top of the cutting edge. While a stone could be manipulated by hand while the blade is held rigid, many of the same dexterity challenges exist with following the compound blade/edge curve: just inverted. This invention eliminates the human error by providing a movable support which sets the angle between the stone and the blade simply and automatically.

The movable support can be designed so that when it is in turn inverted, it can automatically set another suitable angle for sharpening. For example, a combination stone with a coarse grit on one side can be set at an acute 15 degree angle to quickly form the primary bevel, while the other side of the stone has a very fine grit, and the holder when in this orientation forms a 25 degree angle to generate a very small and finely honed/polished secondary bevel. Both angles are formed to very high accuracy, with very little operator skill, and with very little time.

The holder can also be made with multiple slots so that different angles can be selected, or the holder can be made with an eccentric cam which can be rotated to finely adjust the angles, or any number of methods for changing the height of the holder relative to the abrasive stone or rod.

Furthermore, the holder can be made integral with the sharpening rod/plate from one rigid piece of material, for example a bent rod of metal with a different diamond coating grit on the top and bottom surfaces, like the stone example above but in one integral piece.

The blade can be held rigidly on the benchtop by any suitable means, like a magnetic rack, clamps, etc. The mounting surface for the blade can be inclined at a fixed angle to suit the desired cutting-edge angles, in interaction with the stone/rod holder angles. As mentioned, the abrasive holder can also be made to form different angles by any suitable lockable or rigid means, thereby compounding the available edge angles in conjunction with different blade mount angles.

### BRIEF DESCRIPTION OF THE SEVERAL VIEWS OF DRAWINGS

To these and to such other objects that may hereinafter appear, the present invention relates to a knife blade sharpening device and method as described in detail in the following specification and recited in the annexed claims, taken together with the accompanying drawings in which

FIG. 1 is a top view of the sharpening device including the stone and holder with a knife in place to be sharpened;

FIG. 2 is a front view of the device of FIG. 1;

FIG. 3 is a perspective view of the device of FIG. 1;

FIG. 4 is a side view of the device of FIG. 1;

FIG. 5 is a perspective view of the device of FIG. 1 modified to have two different abrasive rod angles;

FIG. 6 is a perspective view of a second preferred embodiment of the holder.

FIG. 7 is a perspective view of another preferred embodiment of the device including a stone in two positions with a spring steel clamp present on the end of the stone setting the angle of the stone;

FIG. 8 is a side view of the device of FIG. 7 viewed from the from the opposite side;

FIG. 9 is a perspective view of the device of FIG. 7 from a different viewpoint;

FIG. 10 is a perspective view of an integral abrasive/clamp unit;

### DETAILED DESCRIPTION OF THE INVENTION

The device for sharpening the cutting edge of a knife blade includes a holder for retaining the knife blade in a fixed position with the cutting edge accessible from a position spaced from the cutting edge. A first end of a moveable abrasive part is aligned with the knife blade. The second end of the abrasive part is retained at a position which determines the angle of the abrasive surface relative to the holder when the first end of the abrasive part contacts the cutting edge. As the abrasive part is moved along the length of the knife blade, the cutting edge is sharpened.

Preferably, the holder retains the knife blade in a position in which the cutting edge is accessible from above and the abrasive part is situated above the holder. In one embodiment, the holder has a said holder have a generally triangular cross-sectional shape.

The second end of the abrasive part is retained in position by a retaining member which may have a ring-shaped body or may take the form of a clamp which can be attached to the end of the abrasive part in more than one position.

The abrasive part may be a stone or a rod with an abrasive surface.

Another aspect of the invention relates to a method of sharpening the cutting edge of a knife blade. The method includes the steps of: attaching the knife blade to a holder in a fixed position with the cutting edge accessible from a position spaced from the cutting edge; aligning one end of an abrasive part with the cutting edge of the knife attached to the holder; retaining the other end of the abrasive part to set the angle of the abrasive part relative to the holder, when the surface of the abrasive part contacts the cutting edge; and moving the abrasive part along the length of the knife blade to sharpen the cutting edge.

The step of attaching the knife to a holder includes retaining the knife blade in a position in which the cutting edge is accessible from above. The method further includes the step of positioning the abrasive part above the holder.

The step of retaining the other end of the abrasive part includes providing a retaining member. The retaining member may have a ring shape or a clamp which can be attached to the end of the abrasive part in more than one position.

The method further includes the step of configurating the holder to have a generally triangular cross-sectional shape.

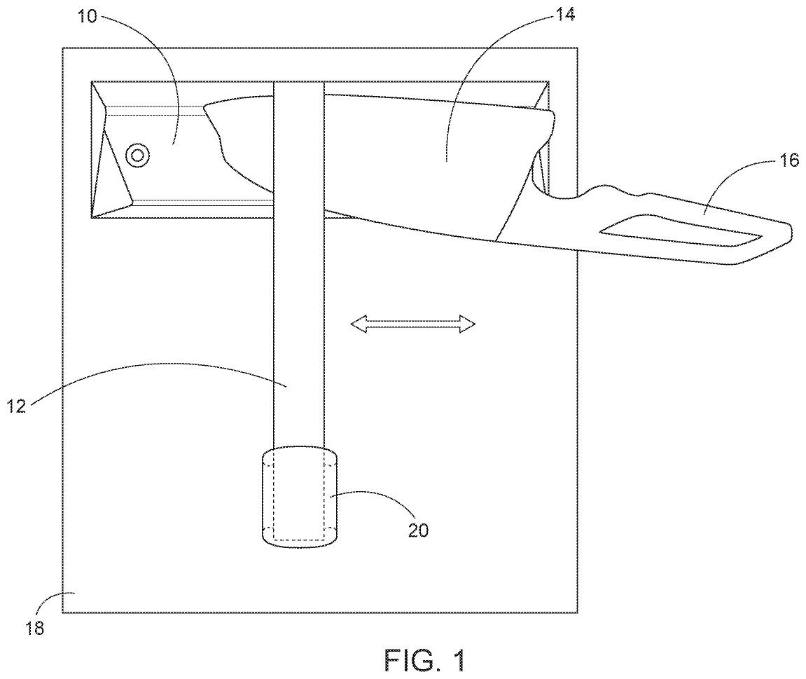

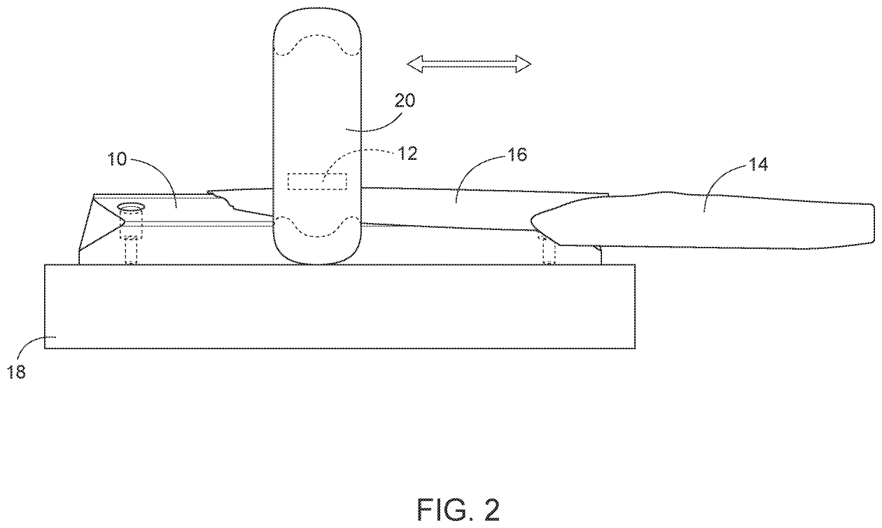

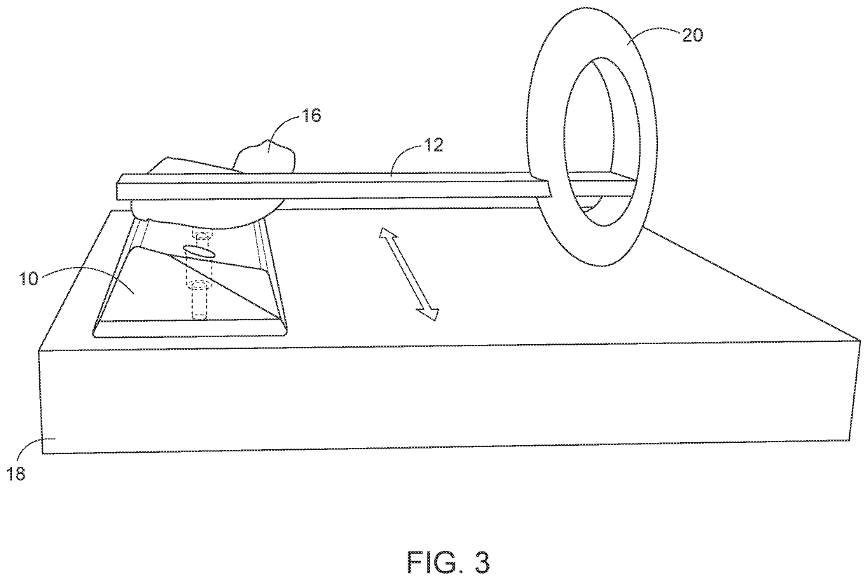

The abrasive part may take the form of a stone or a rod with an abrasive surface. FIGS. 1 through 4 show a first preferred embodiment of the sharpening device in two different inverted positions, selectable by rotating the device 180 degrees. The sharpening device in its simplest form includes a holder 10 and an abrasive part 12. In this embodiment, holder 10 has a generally triangular cross-sectional shape. The holder is used to support the knife in a fixed position during the sharpening process.

The knife includes a blade 14 and a handle 16. In the drawings, the knife is shown in the sharpening position, with blade 14 supported by the holder with the cutting edge of the blade accessible from above. The holder may retain the knife blade on the holder by mechanical means such as a clamp (not shown) or magnetic means as disclosed in another embodiment.

Holder 10 is mounted on base 18 which may take the form of a workbench or any suitable surface which can fix the position of the holder. The height of holder 10 relative to the position of the abrasive part 12 automatically sets the angle of the abrasive part relative to the blade angle. Since the height of the holder usually fixed for any particular device, the angle of the abrasive rod will determine the blade angle.

A retaining member 20, depicted in this embodiment has having a ring-shape, is provided to support the end of abrasive rod 12 remote from the holder. The retaining member sets the angle of the abrasive rod relative to the holder.

During the sharpening process, the knife is held in a fixed position on the holder. The angle of the abrasive rod is set by the retaining member. The abrasive part is held above the knife and the abrasive part is moved back and forth along the length of the knife blade, as seen by the arrows, sharpening the cutting edge of the blade from above.

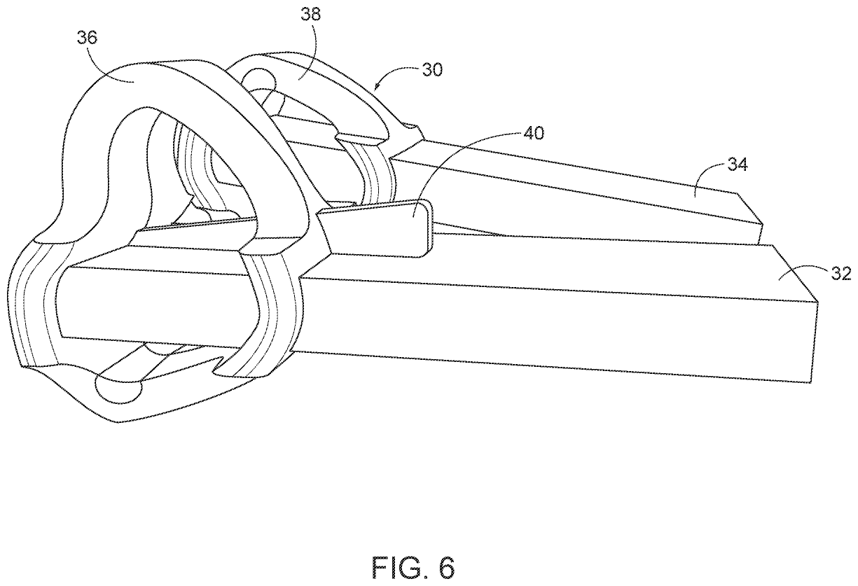

Abrasive part 12 may be a stone, as shown in FIGS. 6-9 or, as illustrated in this embodiment, a rod with an abrasive surface. The abrasive rod may be fabricated of diamond coated metal, ceramic or any other abrasive material suitable for sharpening knives.

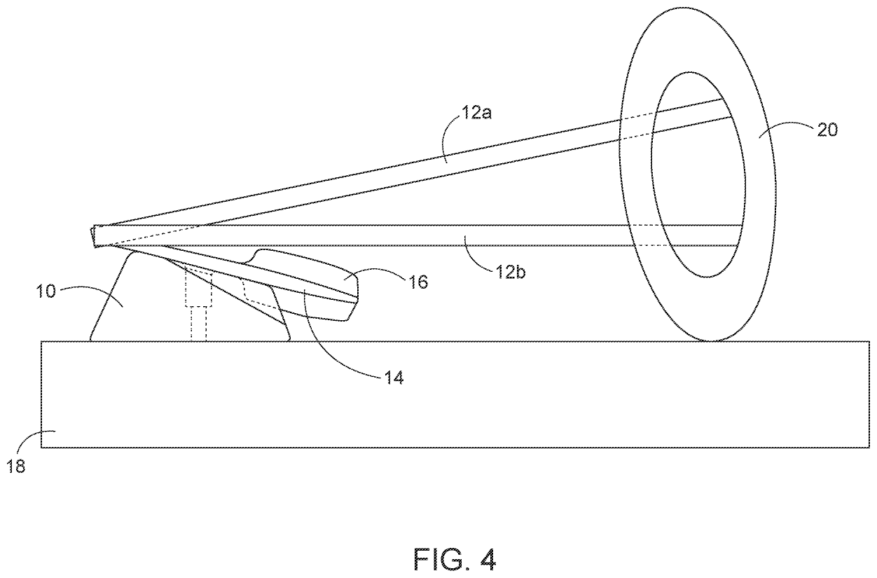

Instead of a single abrasive rod 12, two abrasive rods 12a and 12b can be employed, both connected to a single retaining member 20. As shown in FIG. 4, the rods can be attached to retaining member 20 at different heights to set the rods at different angles relative to the holder.

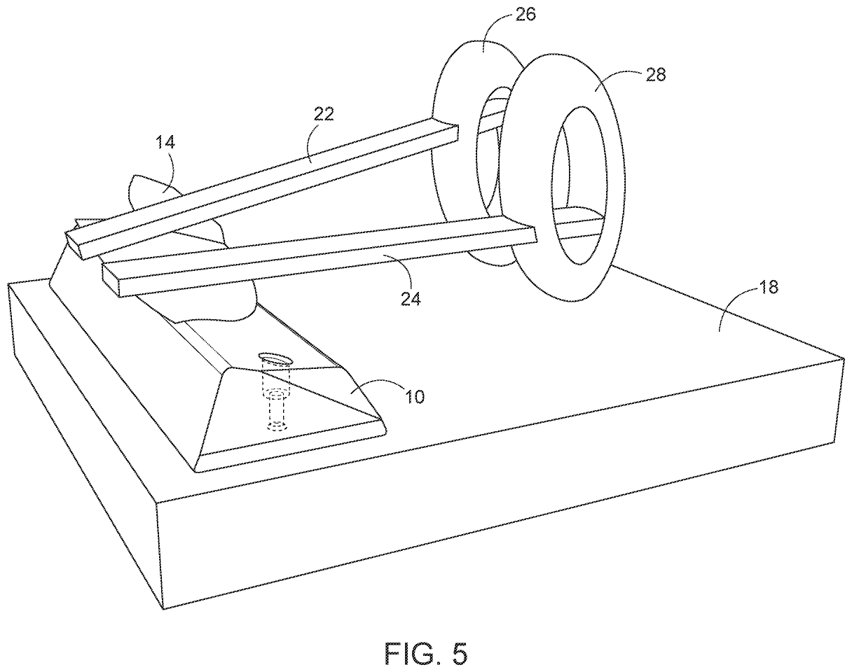

FIG. 5 illustrates another preferred embodiment of the device. In this embodiment, two abrasive rods 22 and 24 are provided at different angles, automatically set by the same holder 10, by rotating the surface supporting the knife on the opposite side of the holder (which could be any suitable shape). Separate retaining members 26 and 28 are provided on the remote ends of the rods.

A highly effective double bevel edge is quickly generated with this embodiment, particularly when the narrow angle, for example 15 degrees, is a relatively coarse abrasive (for quickly shaping the edge), and the wider angle, for example 25 degrees, is a very fine abrasive to hone a small final cutting edge bevel.

The invention generates this famed, and elusive, double bevel cutting edge. Such an edge offers the best of both blade worlds: thin and fine for lower resistance to penetration, and a strong final cutting edge to resist impact damage.

FIG. 6 shows another preferred embodiment of the holder. In this embodiment holder 30 has a more complex design which accommodates abrasive parts in the form of two stones 32 and 34. Holder 30 may be molded or cast. It includes open side pieces 36 and 38 connected at the rear. The holder is provided with a wedge 40 to take up wear in the abrasive part, over time.

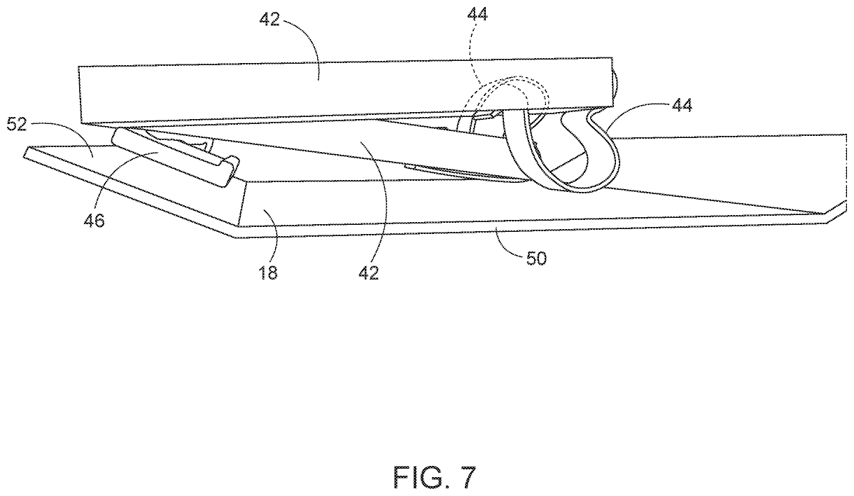

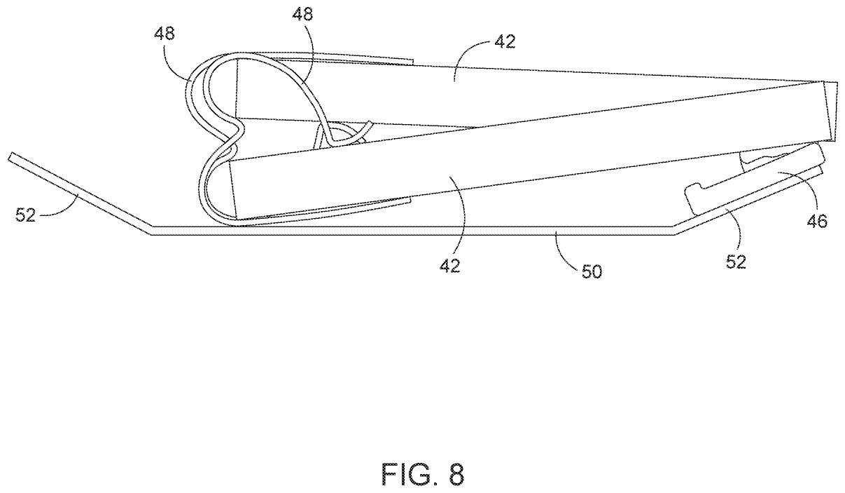

FIGS. 7-9 each show an abrasive stone 42 in two different positions. In this embodiment, a spring steel clamp 44 is attached to the end of the stone remote from the holder. As best seen in FIG. 8, which is a side view, the clamp has two recesses, one on top of the other, which because of the flexibility of the clamp allow the end of the stone to be moved between two different positions on the stone, automatically setting the stone at one of two different angles relative to the blade. Clamps 44 are sized to attach onto the end of a standard stone 44, allowing a wide array of stones to be used, according to user preference.

FIG. 8 illustrates the device of FIG. 7 from the other side. It shows that clamps 42 can have a different height relative to the abrasive stone 44 on each side, thereby automatically setting two different angles relative to the blade. In this embodiment, the holder takes the form of a magnet 46 attached to a metal tray 50 which retains the knife blade. The magnet is secured to the surface section 52 of the tray which has a preset angle, to reduce complexities of the clamps.

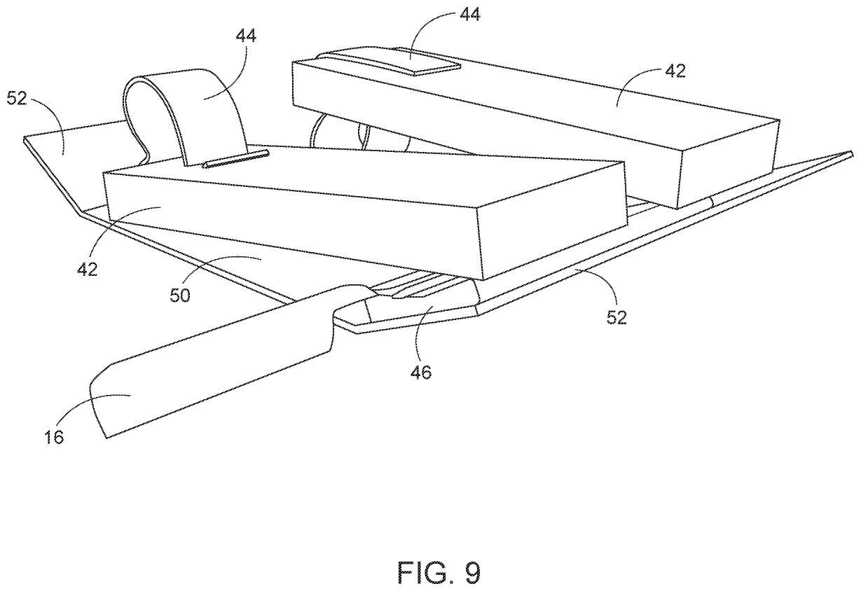

Front and rear sections of tray 50 may include inclined surfaces for the magnetic blade holder, to allow for more variation of edge angles according to user preference. FIG. 9 shows this embodiment in perspective, with the knife in place.

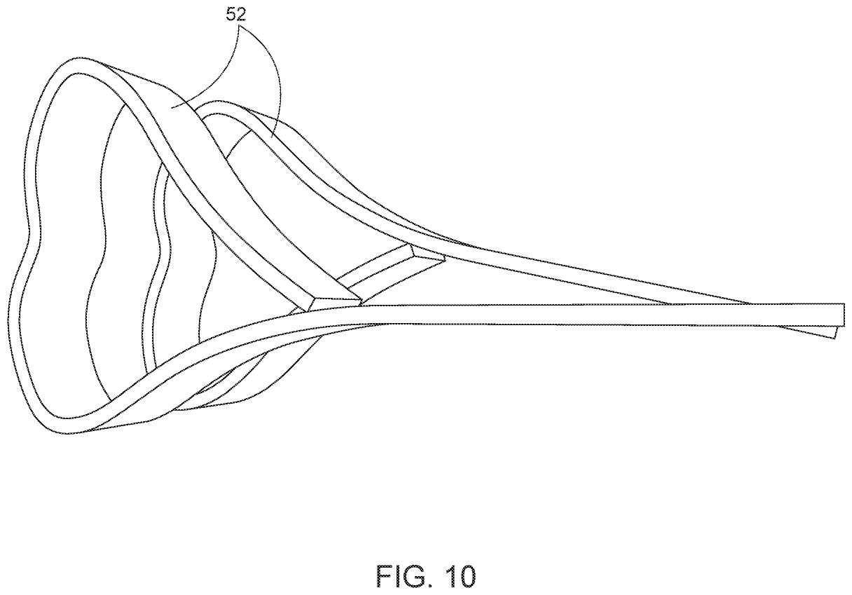

FIG. 10 illustrates a simple and economical integral abrasive/clamp unit 52. Unit 52 could be fabricated by bending a metal rod, using an abrasive coating like industrial diamond for the sharpening and honing. Like the versions with stones or other abrasives, the system could advantageously be used with a relatively coarse abrasive on the orientation with smaller angle, and a fine abrasive for finishing on the orientation with wider angle.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A device for sharpening the cutting edge of a knife blade comprising a holder for retaining the knife blade in a fixed position with the cutting edge accessible from a position spaced from the cutting edge, a moveable abrasive part having first and second ends, and a retaining member supporting said first abrasive part end to set the angle of the abrasive part relative to said holder when said second end of said abrasive part contacts the cutting edge, as the abrasive part is moved along the length of the knife blade to sharpen the cutting edge.

2. The device of claim 1 wherein said holder retains the knife blade in a position in which the cutting edge is accessible from above.

3. The device of claim 1 wherein said abrasive part is situated above said holder.

4. The device of claim 1 wherein said retaining member part has a ring shape.

5. The device if claim 1 wherein said retaining member comprises a clamp.

6. The device of claim 5 wherein said clamp can be attached to said end of said abrasive part in more than one position.

7. The device of claim 1 wherein said holder have a generally triangular cross-sectional shape.

8. The device of claim 1 wherein said abrasive part comprises a stone.

9. The device of claim 1 wherein said abrasive part comprises a rod with an abrasive surface.

10. A method of sharpening the cutting edge of a knife blade comprising the steps of:
(a) attaching the knife blade to a holder in a fixed position with the cutting edge accessible from a position spaced from the cutting edge;
(b) aligning one end of an abrasive part with the cutting edge of the knife attached to the holder;
(c) retaining the other end of the abrasive part to set the angle of the abrasive part relative to the holder, when the surface of the abrasive part contacts the cutting edge; and
(d) moving the abrasive part along the length of the knife blade to sharpen the cutting edge.

11. The method of claim 10 wherein the step of attaching the knife to a holder comprises retaining the knife blade in a position in which the cutting edge is accessible from above.

12. The method of claim 10 further comprising the step of positioning the abrasive part above the holder.

13. The method of claim 10 further comprising the step of providing a retaining member to retain the other end of the abrasive part.

14. The method of claim 10 wherein the retaining member comprises a clamp.

15. The method of claim 14 wherein the clamp can be attached to the end of the abrasive part in more than one position.

16. The method of claim 10 further comprising the step of designing the holder to have a generally triangular cross-sectional shape.

17. The method of claim 10 wherein the abrasive part comprises a stone.

18. The method of claim 10 wherein the abrasive part comprises a rod with an abrasive surface.
